(19) United States
(12) Patent Application Publication
(10) Pub. No.: US 2025/0232243 A1
(43) Pub. Date: Jul. 17, 2025

(54) ELECTRONIC SYSTEMS AND METHODS FOR HYDROCARBON PRODUCING WELLS

(71) Applicant: Ranger Energy Services LLC, Houston, TX (US)

(72) Inventors: Matthew HOOKER, Houston, TX (US); Jason PERRY, Houston, TX (US)

(21) Appl. No.: 19/016,401

(22) Filed: Jan. 10, 2025

Related U.S. Application Data
(60) Provisional application No. 63/620,014, filed on Jan. 11, 2024.

(51) Int. Cl. G06Q 10/0639; G06Q 10/0633; G06Q 50/02

(52) U.S. Cl. CPC G06Q 10/0639; G06Q 10/0633; G06Q 50/02

(57) ABSTRACT

The present embodiments include systems and methods for use with hydrocarbon producing wells. In one embodiment the disclosure pertains to an electronic system. The system comprises a data acquisition interface that receives data relating to a plurality of production wells wherein the data received comprises billing information, payroll information, equipment activity, employee activity, rig activity, production data, workover data, or any combination thereof. The system also comprises a processor operably linked to the data acquisition interface wherein the processor analyzes at least a portion of the data received to generate results. One or more remotely located communication devices are operably linked to the processor and the plurality of production wells. The one or more remotely located communication devices are configured to receive the results and/or transmit operational commands based on the results to one or more production wells in the plurality of production wells.

### FIELD OF THE DISCLOSURE

The present disclosure generally relates to electronic systems and methods for more efficient production and workovers on hydrocarbon producing wells. In particular embodiments, activities on a rig such as sensor data may be correlated with employee and equipment activity to enhance performance of one or more wells.

### BACKGROUND AND SUMMARY OF THE DISCLOSURE

Electronic systems and methods for hydrocarbon producing wells are currently different from and inapplicable to systems associated with drilling wells for a number of reasons. For example, drilling activities are typically conducted by a single vendor acquiring a limited type and amount of data. In contrast, hydrocarbon producing wells often have a service company on site with the operator to conduct the numerous required activities associated with production or, when necessary, workover activities. Also, for hydrocarbon producing wells any data collected is often more diverse and/or complex than simple data acquired in drilling activities.

For hydrocarbon producing wells the service company and operator are often each generating various types of complex data and putting such data into their own systems or sharing such data to be manually input into the other party's systems. This is inefficient and also may result in errors due to there being multiple separate points of potential data entry. Thus, it would be advantageous if there was an electronic system that collected data from both the service company and the operator not as to one well but a plurality of wells. It would further be advantageous if the electronic system could use the aggregated data to analyze and produce useful results to enhance well performance. Advantageously, a system has been developed that meets one or more of the aforementioned needs.

In one embodiment the disclosure pertains to an electronic system for use with hydrocarbon producing wells. The system comprises a data acquisition interface that receives data relating to a plurality of production wells wherein the data received comprises billing information, payroll information, equipment activity, employee activity, rig activity, production data, workover data, or any combination thereof. The system also comprises a processor operably linked to the data acquisition interface wherein the processor analyzes at least a portion of the data received to generate results. One or more remotely located communication devices are operably linked to the processor and the plurality of production wells. The one or more remotely located communication devices are configured to receive the results and/or transmit operational commands based on the results to one or more production wells in the plurality of production wells.

In another embodiment the disclosure pertains to methods of increasing efficiency of hydrocarbon producing wells. The methods involve receiving data by a data acquisition interface. The received data relates to a plurality of production wells and may comprise billing information, payroll information, equipment activity, employee activity, rig activity, production data, workover data, or any combination thereof. At least a portion of the received data is analyzed by, for example, a processor, to generate results. One or more remotely located communication devices receive the results and/or transmit operational commands based on the results to one or more production wells in the plurality of production wells. In this manner enhanced performance of one or more wells or the plurality of wells may be achieved.

Further features of the disclosed systems and methods, and the advantages offered thereby, are explained in greater detail hereinafter with reference to specific example embodiments and/or those illustrated in any accompanying drawings.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments of the invention.

FIG. 1 shows a representative system.

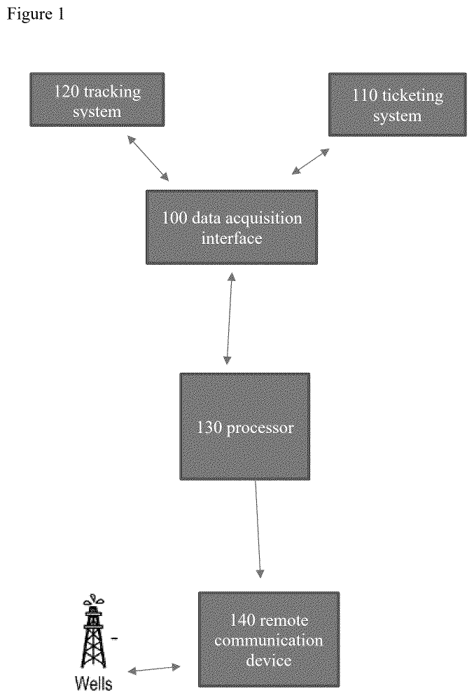

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The electronic systems and methods described herein are useful with hydrocarbon producing wells. The systems and methods for efficient hydrocarbon producing wells are necessarily more complex than systems associated with drilling or other non-producing well activities. The systems and/or methods described herein typically employ a data acquisition interface, a processor, and one or more remotely located communication devices. Of course, other components and/or steps may be employed as desired depending upon the components, desired results, and/or specific characteristics of the well and/or wells, available equipment, and/or desired results of the wells involved. The systems may be employed with a plurality of production wells operated by only one operator or alternatively the systems may be employed on wells operated by multiple operators in which case, if desired, the data collected, aggregated, and employed may be anonymized.

### Data Acquisition Interface

In some embodiments a data acquisition interface 100 is employed in the systems and methods described herein. The exact specifications of any data acquisition interface are not particularly critical and many different types of data acquisition hardware devices may be employed. Typically, the data acquisition interface is capable of receiving or configured to receive data relating to a plurality of production wells. That is, the data acquisition interface is linked in a convenient manner such that it can receive data from multiple sources pertaining to a plurality of wells. Such data received may comprise, for example, billing information, payroll information, equipment activity, employee activity, rig activity, production data, workover data, or any combination thereof. As one of ordinary skill will appreciate workover data may comprise data relating to, for example, production tubing removal data, production tubing replacement data, through tubing data, zonal isolation data, and/or stimulation data.

In some embodiments the data acquisition interface may be a network-enabled computer device operably linked to one or more of the operating or service companies associated with the one or more or plurality of hydrocarbon producing wells. Exemplary network-enabled computer devices include, without limitation, a server, a network appliance, a personal computer, a workstation, or other device capable of receiving, transmitting, and/or processing relatively large amounts of data.

The data acquisition interface is operably linked to a ticketing system 110 and/or a tracking system 120 of a one or more parties on the wellsite. Ticketing systems are often employed by a service company and may comprise, for example, billing information. The billing information may comprise a number of different types of information such as, for example, well identification, personnel information, equipment information, and service details.

The specific tracking system that may be operably linked to the data acquisition interface is not particularly limited. Tracking systems are generally employed by a well operator and such tracking systems are generally employed for managing, organizing, and/or controlling rig activity based on, for example, data obtained from one or more sensors associated with one or more wells. The hardware comprising the operably linked ticketing system and/or tracking system are not limited and may include any of the network-enabled computer devices previously described.

### One or More Processors

One or more processors 130 may also be employed in the systems and methods described herein. The processors may be the same or different hardware than the data acquisition interface. The specific type and capability of such processors are not particularly limited. Representative useful processors may include, for example, processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

In most embodiments the one or more processors are capable of being operably linked to the data acquisition interface. While the one or more processors may be capable of and/or undertake many other related or unrelated activities, the processor(s) employed herein typically are capable of, at a minimum. at least analyzing at least a portion of the data received from the data acquisition interface to generate results.

More specifically, the processor or processors employed herein are typically configured to correlate rig activity (such as activities associated with one or more sensors) with employee and equipment activity. By correlating rig activity with employee and equipment activity, results may be generated that include, for example, recommendations to enhance performance of one or more wells. For example, by correlating asset utilization (both employee and equipment) vs. rig activity across a number of wells and processing the data, recommendation for improved asset utilization may be generated. That is, recommendations may be generated that increase production, reduce employee cost, reduce equipment cost, and/or reduce total cost of running one or more wells.

### One or More Remotely Located Communication Devices

One or more remotely located communication devices 140 may be operably linked to the processor and one or more of the plurality of production wells 150. The specific type of the remotely located communication devices is not particularly limited so long as the device can receive results from the processor about recommended actions to enhance well performance and/or transmit operational commands to one or more production wells. Thus, the remotely located communication device may be, for example, a network-enabled computer device that includes without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. A wearable smart device can include without limitation a smart watch.

As described above, the communication devices are usually remotely located meaning that the device may be located at a different location than the data acquisition interface and/or the one or more processors. In some embodiments, the remotely located communication devices are on the site of one or more of the production wells. The remotely located communication device may be operably connected to the production well where it is located and/or other production wells at other sites. By being operably connected to one or more of the plurality of production wells the communication device may transmit instructions to one or more controllers associated with the well to take certain actions. Such actions may include those described previously to enhance production.

### EMBODIMENTS

1. An electronic system for use with hydrocarbon producing wells wherein the system comprises:
a data acquisition interface that receives data relating to a plurality of production wells wherein the data received comprises billing information, payroll information, equipment activity, employee activity, rig activity, production data, workover data, or any combination thereof;
a processor operably linked to the data acquisition interface wherein the processor analyzes at least a portion of the data received to generate results; and
one or more remotely located communication devices that are operably linked to the processor and one or more of the plurality of production wells wherein the one or more remotely located communication devices are configured to receive the results and/or transmit operational commands based on the results to one or more production wells in the plurality of production wells.

2. The system of embodiment 1 wherein the data acquisition interface is operably linked to a ticketing system and a tracking system.

3. The system of embodiment 2 wherein the ticketing system comprises billing information and is a service company's ticketing system.

4. The system of embodiment 3 wherein the billing information comprises well identification, personnel information, equipment information, and service details.

5. The system of embodiment 2 wherein the tracking system comprises rig activity.

6. The system of embodiment 5 wherein rig activity comprises data from one or more sensors.

7. The system of embodiment 1 wherein the processor is configured to correlate rig activity with employee and equipment activity to generate the results and wherein the results comprise recommendations to enhance performance of one or more wells.

8. The system of embodiment 7 wherein the enhanced performance of one or more wells comprises one or more of increased production, reduced employee cost, reduced equipment cost, and reduced total cost.

9. The system of embodiment 1 wherein the workover data comprises production tubing removal data, production tubing replacement data, through tubing data, zonal isolation data, and stimulation data.

10. The system of embodiment 1 wherein the plurality of production wells are owned by a single customer.

11. The system of embodiment 1 wherein the production wells in the plurality of production wells are owned by more than one customer.

12. The system of embodiment 1 wherein the one or more remotely located communication devices comprise a tablet, a smart phone, a laptop, or a desktop.

13. A method of increasing efficiency of hydrocarbon producing wells comprising:
receiving data by a data acquisition interface wherein the data relates to a plurality of production wells wherein the data received comprises billing information, payroll information, equipment activity, employee activity, rig activity, production data, workover data, or any combination thereof;
analyzing, by a processor, at least a portion of the data received to generate results; and
receiving, by one or more remotely located communication devices, the results and/or transmitting operational commands based on the results to one or more production wells in the plurality of production wells.

14. The method of embodiment 13 further comprising correlating rig activity with employee and equipment activity to generate the results.

15. The method of embodiment 13 further comprising using the results to provide recommendations to enhance performance of one or more wells.

16. The method of embodiment 13 further comprising using the results to enhance performance of one or more wells.

17. The method of embodiment 16 wherein the enhanced performance comprises one or more of increased production, reduced employee cost, reduced equipment cost, and reduced total cost.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above-described embodiments, method, and examples, but by all embodiments within the scope and spirit of the invention as claimed.

Further, it is to be understood that the terminology used herein is for the purpose of describing particular embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper,” “lower,” “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes, and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

What is claimed is:

1. An electronic system for use with hydrocarbon producing wells wherein the system comprises:
a data acquisition interface that receives data relating to a plurality of production wells wherein the data received comprises billing information, payroll information, equipment activity, employee activity, rig activity, production data, workover data, or any combination thereof;
a processor operably linked to the data acquisition interface wherein the processor analyzes at least a portion of the data received to generate results; and
one or more remotely located communication devices that are operably linked to the processor and one or more of the plurality of production wells wherein the one or more remotely located communication devices are configured to receive the results and/or transmit operational commands based on the results to one or more production wells in the plurality of production wells.

2. The system of claim 1 wherein the data acquisition interface is operably linked to a ticketing system and a tracking system.

3. The system of claim 2 wherein the ticketing system comprises billing information and is a service company's ticketing system.

4. The system of claim 3 wherein the billing information comprises well identification, personnel information, equipment information, and service details.

5. The system of claim 2 wherein the tracking system comprises rig activity.

6. The system of claim 5 wherein rig activity comprises data from one or more sensors.

7. The system of claim 1 wherein the processor is configured to correlate rig activity with employee and equipment activity to generate the results and wherein the results comprise recommendations to enhance performance of one or more wells.

8. The system of claim 7 wherein the enhanced performance of one or more wells comprises one or more of increased production, reduced employee cost, reduced equipment cost, and reduced total cost.

9. The system of claim 1 wherein the workover data comprises production tubing removal data, production tubing replacement data, through tubing data, zonal isolation data, and stimulation data.

10. The system of claim 1 wherein the plurality of production wells are owned by a single customer.

11. The system of claim 1 wherein the production wells in the plurality of production wells are owned by more than one customer.

12. The system of claim 1 wherein the one or more remotely located communication devices comprise a tablet, a smart phone, a laptop, or a desktop.

13. A method of increasing efficiency of hydrocarbon producing wells comprising:
receiving data by a data acquisition interface wherein the data relates to a plurality of production wells wherein the data received comprises billing information, payroll information, equipment activity, employee activity, rig activity, production data, workover data, or any combination thereof;
analyzing, by a processor, at least a portion of the data received to generate results; and
receiving, by one or more remotely located communication devices, the results and/or transmitting operational commands based on the results to one or more production wells in the plurality of production wells.

14. The method of claim 13 further comprising correlating rig activity with employee and equipment activity to generate the results.

15. The method of claim 13 further comprising using the results to provide recommendations to enhance performance of one or more wells.

16. The method of claim 13 further comprising using the results to enhance performance of one or more wells.

17. The method of claim 16 wherein the enhanced performance comprises one or more of increased production, reduced employee cost, reduced equipment cost, and reduced total cost.
